(19) United States
(12) Patent Application Publication
(10) Pub. No.: US 2011/0285145 A1
(43) Pub. Date: Nov. 24, 2011

(54) ALTERNATIVE DRIVER DEVICE FOR AN ELECTRICAL GENERATOR

(75) Inventor: GUSTAVO GONZALEZ, Miami, FL (US)

(73) Assignee: Mr. Gustavo Gonzalez, Miami, FL (US)

(21) Appl. No.: 12/783,932

(22) Filed: May 20, 2010

(51) Int. Cl. H02K 7/18; F03B 13/18; F03G 7/10

(52) U.S. Cl. 290/1 C; 290/53; 74/DIG. 9

(57) ABSTRACT

a mechanism to produce the revolutions required by an electrical generator. This mechanism consists of a fixed frame with a ramp in helical form around an internal axis in vertical position. The ramp supports spheres that are pushed to the top of the ramp by bars, parallel to the axis and attached to it.

The axis is connected on one end to a wheel in a horizontal position; this wheel is propelled by electrical motors fixed on the frame; on the side of the ramp is located an upright wheel, with baskets in the rim; when the spheres reach the top of the ramp, they are placed one by one on the baskets, and the wheel starts turning by the weight of the spheres.

Attached to the wheel is a driver sheave that drives a gear box; this gear box produces the revolutions required to drive an electrical generator.

The electrical generator produces energy for the motors that propel the horizontal wheel, and also produces energy for external use; this condition makes this generator independent of any external power or any fuel.

The horizontal wheel can be replaced by a system that transforms the movement of ocean waves into circular motion. This system consists of a float held by a cable tied in helical form to an axis; another cable tied in helical form to the same axis holds a counterbalance weight. The float is heavier than the counterbalance weight and both are tied to the same axis through pulleys. The movement of ocean waves makes the float go up or down inside a vertical cage; this movement in the float causes a movement in opposite direction of the counterbalance weight and the axis turns clockwise and counterclockwise alternatively. This rotation is transmitted through gears to the main system.

The ocean waves can be replaced by a stream of water, using a rotational mechanism.

### FIELD OF INVENTION

This invention is related to a system which develops rotational movement to operate an electrical generator or a turbine. This system uses feedback energy produced by the same generator, or rotational movement produced by the waves of the ocean or a river stream.

### DESCRIPTION OF PRIOR ART

Current electrical generators use fuels that produce toxic gases and environmental contamination. Further, electrical generators utilize combustion materials that are very dangerous to handle for inexperienced people. These generators have to be located in open spaces due to their toxicity.

### OBJECTS AND ADVANTAGES

The purpose of this mechanism is to produce the torque and speed to energize a belt driven generator. This is accomplished by two methods; the first method is by feeding back the energy produced by the same generator. In this case the mechanism can be located in any open or closed place. It can be operated continuously for it does not need fuel or external energy, and does not overheating.

The second method is by using the energy produced by the waves of the ocean or a river stream.

In both methods the mechanism does not produce pollution, does not use fuels, does not overheat, and is less noisy than most electrical generators.

The dimensions of this device comply with the necessary requirements; it can be small or large according to the demands of the user.

Finally, it is cost effective because it does not require fuel for operation and the construction is more durable than most electrical generators.

### DESCRIPTION OF DRAWINGS

FIG. 1 shows a perspective view of the different components of the system.

FIG. 2 shows a perspective view of the main frame, a circulating helix-ramp, a circulating helix-support bar, a wheel with baskets in its periphery, and a driver sheave.

FIG. 3 shows a perspective view of an helix-ramp loaded with spheres, an helix-support bar, an axis assembled with a driver wheel and platforms that hold driver bars; a wheel with baskets in the rim loaded with spheres and an electrical generator.

FIG. 4 shows a perspective view of a gear-box comprising driver sheaves, belts and an electrical generator.

FIG. 5 shows a perspective view of a rotor using helix bars.

FIG. 6 shows a perspective view of the system using the waves of the ocean to produce the rotational movement.

FIG. 7 shows a perspective view of the system using a river stream.

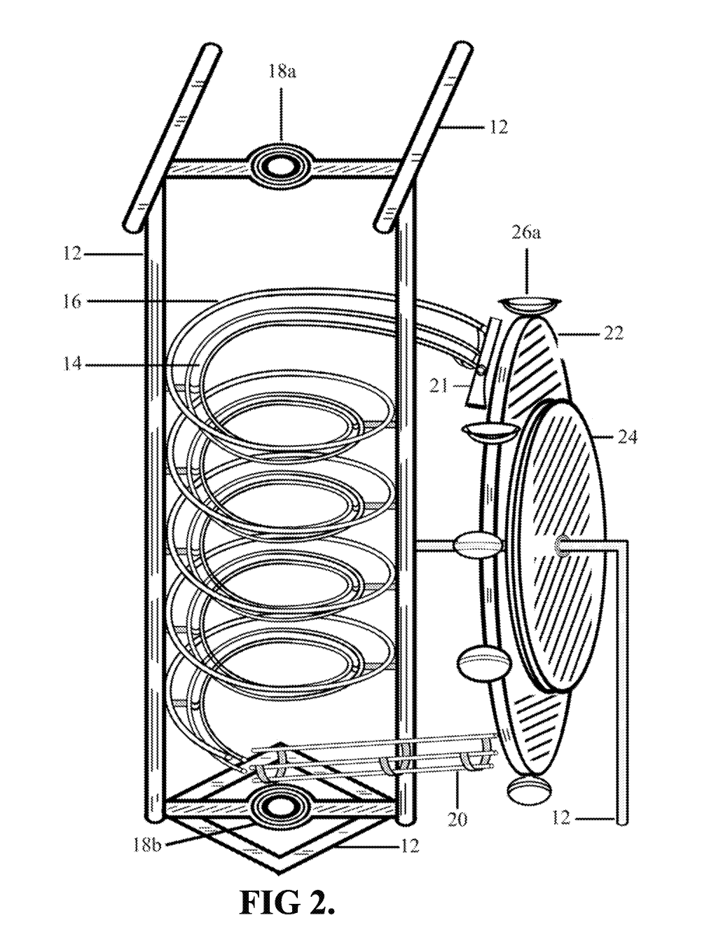

List of Reference Numerals:
FIG. 2

| | | | |
|---|---|---|---|
| 12 | FRAME | 21 | GATE |
| 14 | CIRCULAR HELIX-RAMP | 22 | UPRIGHT WHEEL |
| 16 | CIRCULAR HELIX-BAR SUPPORT | 24 | DRIVER SHEAVE |
| 18 a, b | BEARING | 26 a, b, c, d, e | BASKET |
| 20 | LOADING TRAY | | |

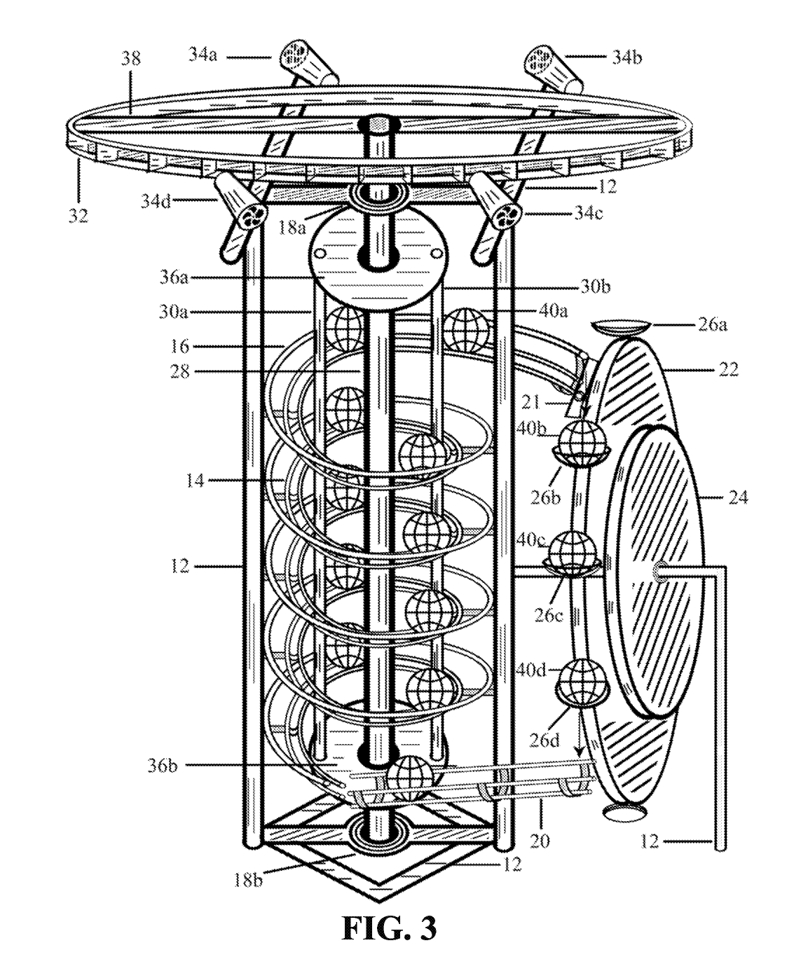

FIG. 3

| | | | |
|---|---|---|---|
| 28 | MAIN AXIS | 36 a, b, | PLATFORM |
| 30 a, b, | DRIVER BAR | 38 | BEAM |
| 32 | DRIVER WHEEL | 40 a, b, c, d, e, | SPHERE |
| 34 a, b, c, d, | ELECTRICAL MOTOR | | |

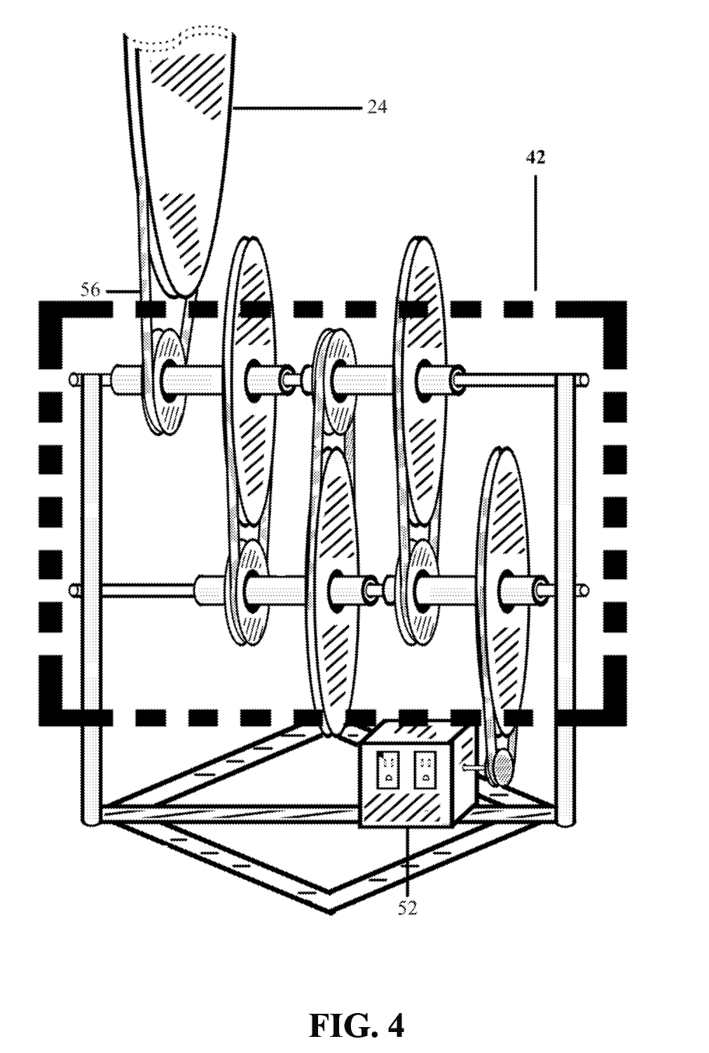

FIG. 4

| | | | |
|---|---|---|---|
| 24 | DRIVER SHEAVE | 52 | ELECTRICAL GENERATOR |
| 42 | GEAR BOX | 56 | BELT |

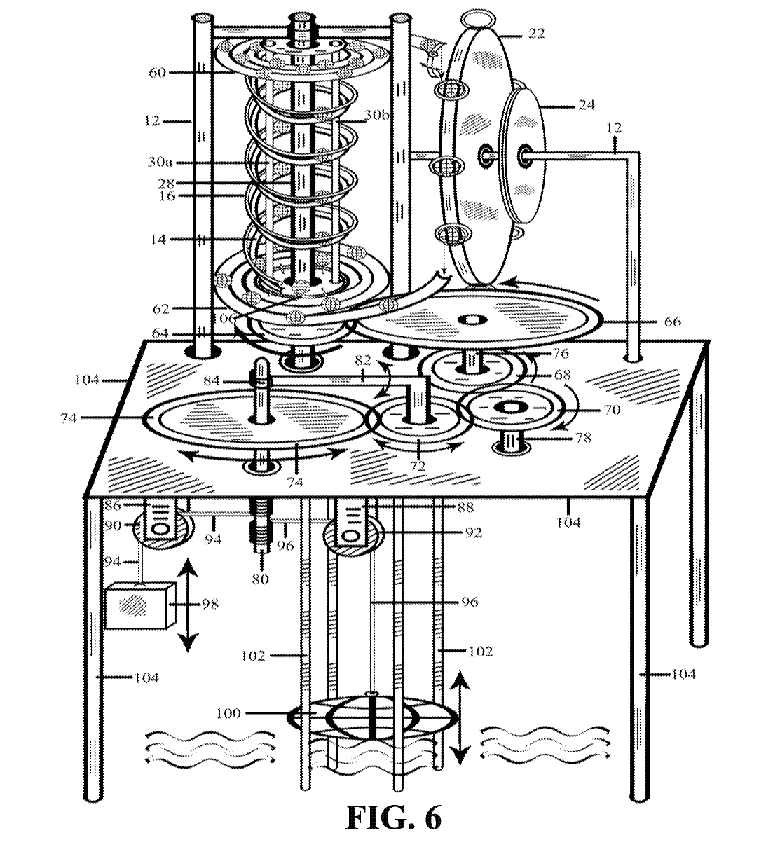

FIG. 6

| | | | |
|---|---|---|---|
| 60 | SPIRAL TRAY | 84 | BEARING |
| 62 | SPIRAL TRAY | 86 | PLATE |
| 64 | GEAR | 88 | PLATE |
| 66 | GEAR | 90 | PULLEY |
| 68 | GEAR | 92 | PULLEY |
| 70 | GEAR | 94 | CABLE |
| 72 | GEAR | 96 | CABLE |
| 74 | GEAR | 98 | COUNTERBALANCE WEIGHT |
| 76 | AXIS | 100 | FLOAT |
| 78 | AXIS | 102 | CAGE |
| 80 | AXIS | 104 | SUPPORT PLATFORM |
| 82 | MOVING ARM | 106 | STOPPER |

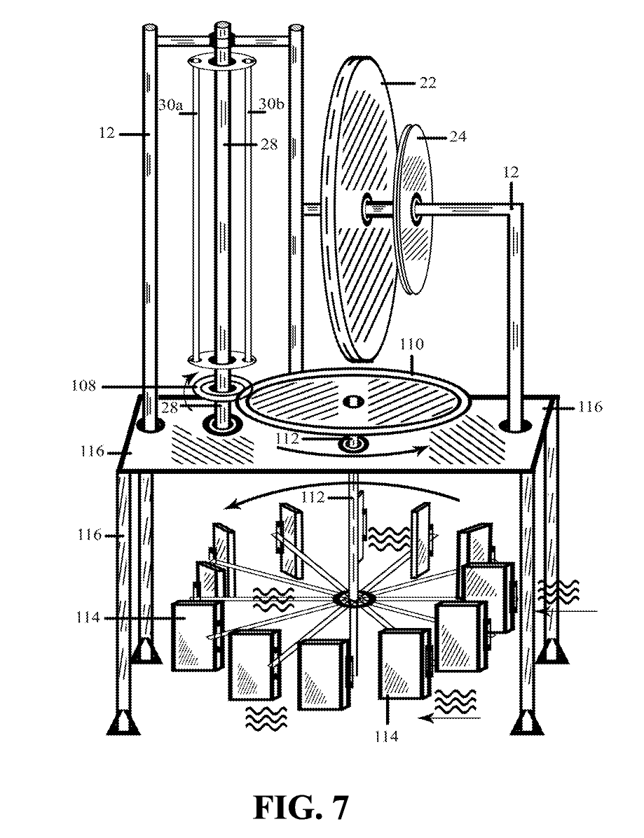

FIG. 7

| | | | |
|---|---|---|---|
| 108 | GEAR | 114 | PROPELLER |
| 110 | GEAR | 116 | PLATFORM |
| 112 | AXIS | | |

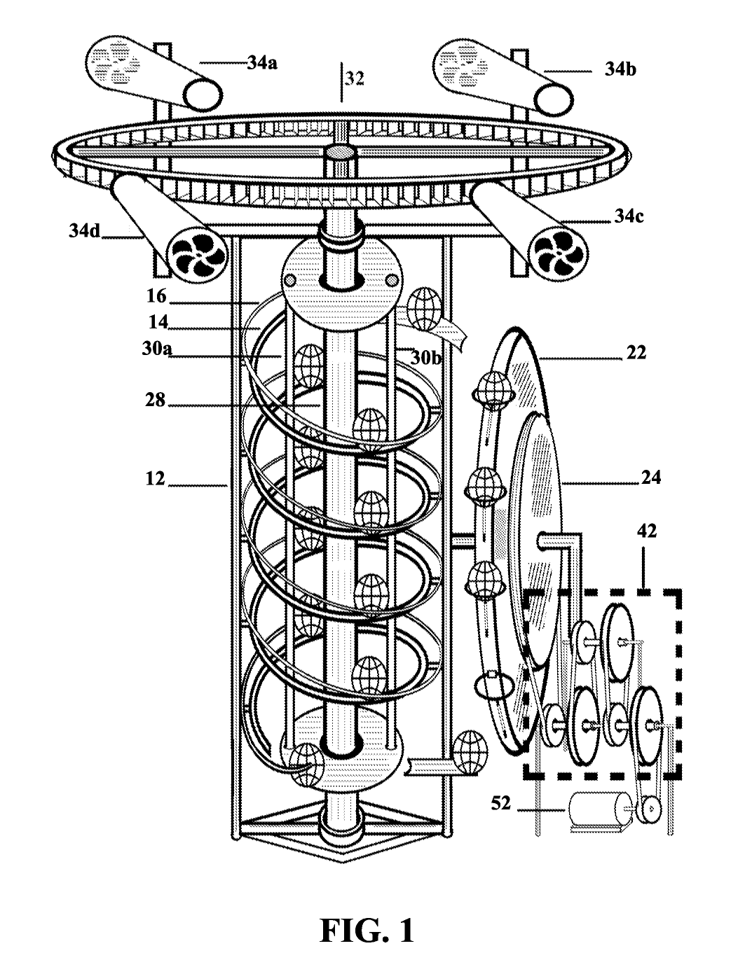

### Description-FIG. 1 to 7:

FIG. 1 shows the first method of the system consisting of a frame 12 that sustains a ramp 14 in helical form; a bar 30a and a bar 30b attached to an axis 28; a driver wheel 32 propelled by motors 34a, 34b, 34c and 34d. The frame 12 supports an upright wheel 22 and a driver sheave 24 attached to wheel 22; a gear box 42 and an electrical generator 52.

FIG. 2 shows in detail the frame 12, helix-ramp 14 built by two bars, helix-support bar 16; wheel 22 with baskets 26a, 26b, etc. incorporated in its periphery; driver sheave 24 attached to wheel 22; a bushing 18a and a bushing 18b embedded in the frame 12; a loading tray 20; a gate 21 attached to the ramp 14.

FIG. 3 shows ramp 14 with a helix-support bar 16, an axis 28 propelled by a driver wheel 32. A beam 38 that connects wheel 32 and axis 28. Electrical motors 34a, 34b, 34c, 34d, symbolized by blowers; platforms 36a and 36b incorporated to axis 28; bars 30a and 30b connected to platforms 36a and 36b; spheres on ramp 14 and in baskets 26a, 26b, 26c etc; wheel 22 supporting baskets, and driver sheave 24; loading tray 20 that transport spheres from wheel 22 to the ramp 14.

FIG. 4 shows a gearbox 42 made up of several sets of driver sheaves. The initial set is connected to driver sheave 24 by belt 56. The last set of the gearbox is connected to power generator 52.

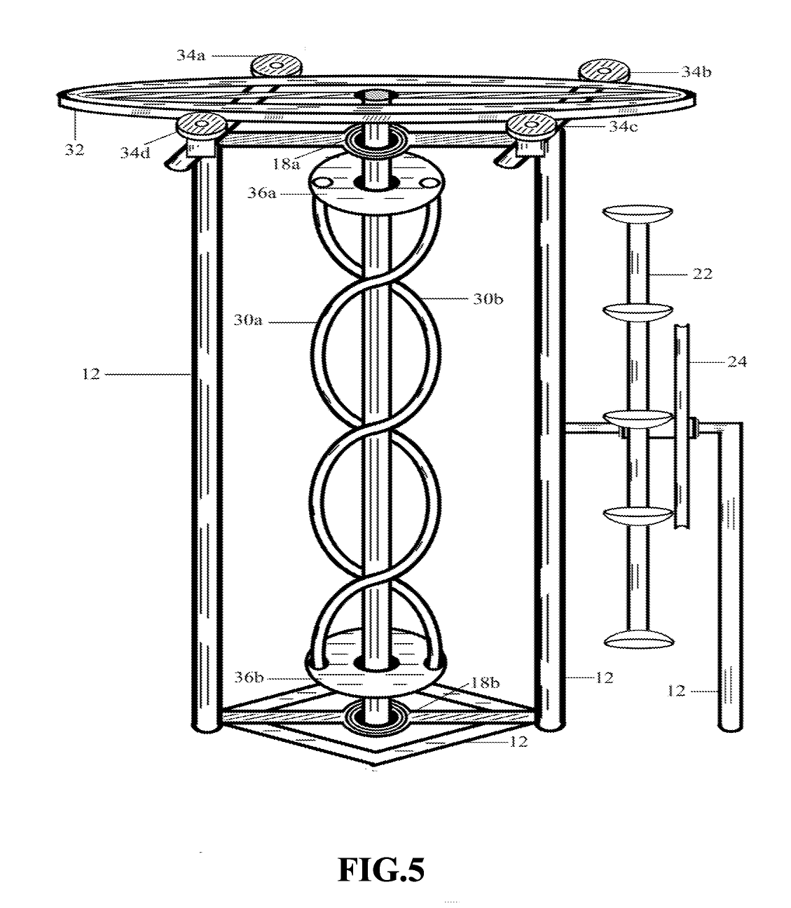

FIG. 5 shows a rotor where straight bars 30a, and 30b have been replaced by helix-bars; wheel 32 has been modified to be driven by motors with rollers 34a, 34b, 34c, 34d in replacement of blowers, but its function is the same.

FIG. 6 shows the second method of the system where the wave motion of the ocean produces a rotating motion on the mechanism. A cable 96 tied in helical form to an axis 80 holds a float 100 through a pulley 92; a counterbalance weight 98 is held by a cable 94 through a pulley 90, tied in an helical form to axis 80; pulley 92 is fixed to a platform 104 by a plate 88, pulley 90 is fixed to platform 104 by a plate 86; axis 80 is embedded in platform 104 and supports a gear 74; axis 80 also supports an arm 82 through a bearing 84; arm 82 supports a gear 72 which drives alternatively an idle gear 70 or a gear 68; a gear 70 is sustained by an axis 78 fixed to platform 104, gear 68 is sustained by an axis 76 fixed to platform 104; axis 76 connects gear 68 with a gear 66 connected with a gear 64 sustained by an axis 28 of the rotor of the system; frame 12 supports a spiral tray 60 and a spiral tray 62; a stopper 106 in the spiral tray 62; a cage 102 for the float 100; a platform 104 that sustains the system.

FIG. 7 shows a propeller 114 connected by an axis 112 to a gear 110 which drives a gear 108 fitted in an axis 28; a platform 116 that sustains the system.

### Operation:

FIG. 3 shows the system in operation. The first load becomes by external force. The spheres are provided to ramp 14 by the loading channel 20 and they ascend by ramp 14 pushed by bars 30a and 30b, as the wheel 32 turns. These spheres are supported by ramp 14 and helix-support bar 16. The elevation angle of ramp 14 can be very small because the ramp 14 is sufficiently long. The effort to raise a sphere on an elevation angle of 9 degrees is near ten percent of the weight of the sphere; this effort is diminished by the action of the wheel 32 whose radius constitutes a lever that turns the axis 28 and platforms 36a and 36b together with bars 30a and 30b, leading the spheres onto the ramp 14. Some system of magnetic levitation can be used to diminish the frictional force. Wheel 32 is constructed to be driven by electrical motors 34a, 34b, 34c, and 34d. The dimension of wheel 32 depends on the required number of rotations and the weight of the spheres.

FIG. 4 shows a driver sheave 24 driving gear-box 42 by belt 56; gear-box 42 drives electric head-driver generator 52.

FIG. 5 shows wheel 32 propelled by roller-motors 34a, 34b, 34c, 34d; straight bars 30a and 30b have been replaced by helix-bars. This FIG. 5 shows that the system can use different ways to get the best performance according to the circumstances.

FIG. 6 shows a propelling mechanism driven by the waves of the ocean. Float 100 ascends or descends according to the movement of the waves. Cage 102 conditions the float 100 to vertical displacement. When float 100 descends it pulls cable 96 tied to axis 80 through pulley 92; axis 80 turns clockwise and pulls counterweight 98, tied to axis 80 by cable 94; as axis 80 turns clockwise, gear 74 turns as well and drags gear 72 until hooking with idle gear 70; gear 70 transmits the motion to gear 68; gear 68 is connected with gear 66 through axis 76; gear 66 transmits the movement to gear 64 in main axis 28; axis 28 turns and drags the propelling bars 30a and 30b, leading the spheres to the superior part of the ramp 14.

When float 100 ascends by the impulse of the wave, counterweight 98 descends pulling cable 94 and causes counterclockwise rotation on axis 80 and gear 74; gear 74 drags gear 72 until hooking with gear 68; gear 68 transmits the movement to gear 66 and gear 64, turning main axis 28.

Spiral-tray 60 is placed on the top of the ramp 14 and another spiral-tray 62 on the bottom of the ramp 14; these spiral-trays intend to store spheres; at the moment of greater activity the spheres are stored in the top spiral-tray 60, and at the moments of calm the spheres are stored in the bottom spiral-tray 62.

The smallest movement of float 100 induces a turn on axis 80 and this turn is multiplied by the relation between gears 74 and 68, and gears 66 and 64; float 100 has a weight heavier than counterweight 98; if the difference is double, the torque of rotation of axis 80 will always be the same when the float 100 goes up or down.

The rotor of the system always turns in clockwise direction; to prevent the rotor to turn counterclockwise at the moment of transition between the raising and lowering of float 100, stopper 106 has been placed on spiral-tray 62.

FIG. 7 shows a propeller 114 that turns in the same direction taking advantage of a river stream; propeller 114 is joined with gear 110 by an axis 112 embedded in the platform 116; gear 110 transfer rotations to gear 108 joined to main axis 28.

### SUMMARY

This is a system to produce a rotational movement to drive an electrical generator. It consists of an incline-plane or ramp in form of a circular helix with a small angle of elevation. This incline-plane or ramp is the path for spherical volumes to ascent, pushed by propelling bars connected to a central axis. The rotation of this axis is achieved by two different methods. In the first method the axis is connected to a wheel that acts like a lever. The wheel is activated by electrical motors.

In the second method the axis is connected to gears or driver sheaves activated by the movement of ocean waves or by a river stream.

The spheres pushed by the propelling bars ascent to the top of the ramp and are deposited in baskets placed on the periphery of a wheel situated alongside and contiguous to the ramp. The weight of the spheres causes the wheel to rotate by the force of gravity. This wheel activates a gear-box connected to a belt driven generator.

The angle of elevation of the ramp is very small and therefore the required force to propel the spheres up is minimal because the weight of the spheres rest in the ramp. This means that the effort to raise the spheres diminishes in direct proportion to the angle of elevation of the ramp; the force of gravity of each sphere is amplified by the radius of the wheel. This condition makes it possible for this system to operate.

The construction of the mechanism is simple because it is designed with already existing elements. The gearbox can be constructed with driver sheaves or gears.

The regular speed of the wheel makes the construction of the gearbox very simple.

Quieter, more cost effective systems, without the danger of toxic residue are some of the advantages of using a system that uses electrical energy without combustion or contamination making them better alternatives to other electrical energy generators.

What is claimed is:

1. A mechanism to generate revolutions to drive an electrical generator that includes:
an incline or ramp in helical form attached to a frame;
an axis in the internal part of the ramp, embedded in the frame by bushings;
vertical bars joint to the axis by platforms;
a wheel attached to the axis in perpendicular position;
a plurality of electrical motors fixed to the frame and contiguous to the periphery of the wheel;
spherical volumes that are dragged on the ramp by the vertical bars;
an upright wheel with baskets attached to the rim, placed on the external side of the ramp;
a driver sheave attached to the upright wheel;
a gear box connected to the driver sheave; a generator connected to the gear box.

2. A mechanism using the movement of the waves of the ocean to produce rotational movement, to replace the wheel perpendicular to the axis in claim 1, that includes:
an axis connected to a set of gears that drives the main axis of claim 1;
a float tied to the axis by a cable through a pulley;
a counterbalance weight tied to the axis by a cable through a pulley;
a cage that confines the float for vertical movements.

3. The spherical volumes of claim 1, where the spherical volumes at the top of the ramp are placed in a basket on the upright wheel, one by one.

4. The electrical head generator of claim 1, where the head generator produces electricity for the motors which propel the wheel perpendicular to the main axis and for external use as well.

5. The cables of claim 2 that hold the float and the counterbalance weight, where the cables are coiled to the axis of claim 2 in helical form.

6. The float of claim 2, where the float is heavier than the counterbalance weight.
